(19) United States
(12) Patent Application Publication
(10) Pub. No.: US 2007/0060105 A1
(43) Pub. Date: Mar. 15, 2007

(54) System and method for optimizing a wireless connection between wireless devices

(76) Inventor: Puneet Batta, Santa Clara, CA (US)

Correspondence Address: FAY KAPLUN & MARCIN, LLP, 15O BROADWAY, SUITE 702, NEW YORK, NY, 10038, US

(21) Appl. No.: 11/218,026

(22) Filed: Aug. 31, 2005

(51) Int. Cl. H04M 3/16

(52) U.S. Cl. 455/410

(57) ABSTRACT

Described is a method where a wireless mobile unit (“MU”) transmits an association request and an authentication request to an access point (“AP”). The association request includes an identifier of the MU and the authentication request includes authentication data of the MU. An authentication procedure of the MU is performed as a function of the identifier and the authentication data. The AP adds the identifier and the authentication data to an authenticated list. Access to the list is provided to at least one further AP. When the at least one further AP receives a further association request including the identifier from the MU, the further AP performs a further authentication procedure as a function of the identifier and the list.

### BACKGROUND INFORMATION

A conventional wireless network includes one or more access points (“APs”) allowing a user of a mobile unit (“MU”) to move freely within the network while maintaining a connection thereto. As the MU moves within the network, it may communicate with different APs as it moves to different locations. When the MU ceases communicating with a first AP and begins communicating with a second AP, it is commonly referred to as a roam.

To initiate communication with the second AP, the MU may execute a roam procedure which was previously executed with the first AP. The roam procedure includes an association and an authentication of the MU with the second AP, and may be completed in approximately 200 milliseconds to 3 seconds. Thus, the association and authentication with each AP may cause a delay in the communication. For many applications (e.g., Voice over Internet Protocol (“VoIP”)), the delay may result in a termination of the connection of the MU to the network.

### SUMMARY OF THE INVENTION

The present invention relates to a method where a wireless mobile unit (“MU”) transmits an association request and an authentication request to an access point (“AP”). The association request includes an identifier of the MU and the authentication request includes authentication data of the MU. An authentication procedure of the MU is performed as a function of the identifier and the authentication data. The AP adds the identifier and the authentication data to an authenticated list. Access to the list is provided to at least one further AP. When the at least one further AP receives a further association request including the identifier from the MU, the further AP performs a further authentication procedure as a function of the identifier and the list.

### BRIEF DESCRIPTION OF THE DRAWINGS

FIG. 1 shows an exemplary embodiment of a system according to the present invention;

FIG. 2 shows an exemplary embodiment of a method according to the present invention; and

FIG. 3 shows an exemplary embodiment of another method according to the present invention.

### DETAILED DESCRIPTION

The present invention may be further understood with reference to the following description and the appended drawings, wherein like elements are provided with the same reference numerals. The present invention discloses a system and method for optimizing a wireless connection between wireless devices. Although the present invention may be described with reference to an IEEE 802.11 wireless network, those of skill in the art will understand that the present invention may be utilized with other types of network protocols and architectures.

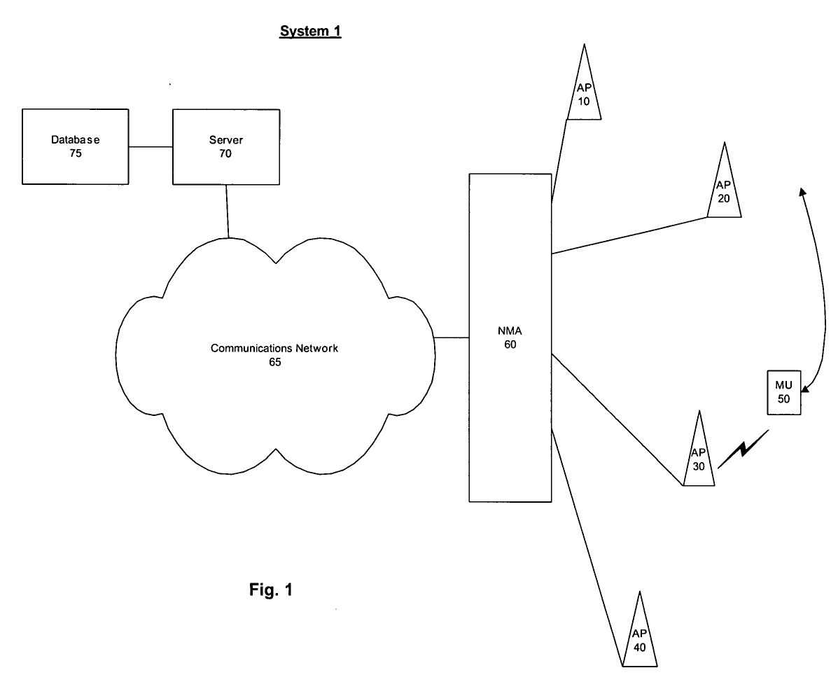

FIG. 1 shows an exemplary embodiment of a system 1 according to the present invention. The system 1 may include a WLAN comprising a network management arrangement (“NMA”) 60 coupled to access points (“APs”) 10, 20, 30, and 40. Each of the APs 10-40 may have a corresponding coverage area which defines a range over which the AP may transmit and receive a radio frequency (“RF”) signal. A mobile unit (“MU”) 50 located within a particular coverage area may communicate with a corresponding AP. For example, the MU 50 may be located in the coverage area of the AP 30 and communicate therewith. Those of skill in the art will understand that the coverage areas may overlap, such that MU 50 may receive RF signals from more than one AP. However, the MU 50 may only associate and communicate with one AP at a time.

Each AP 10-40 broadcasts a beacon at predetermined intervals to advertise its presence to other wireless devices in its coverage area. The beacon includes a source address (e.g., a Basic Service Set identification (“BSSID”)) which identifies the AP. The beacon further includes a network identifier (e.g., an Extended Service Set identifier (“ESSID”)) and some encryption data regarding the Extended Service Set. The MU 50, after receiving the beacon from the AP 30, may transmit an association request to the AP 30. The association request may be a frame which includes information related to the MU 50 (e.g., supported data rates) and a signal strength identifier of the network 65 with which it seeks association. The AP 30 may grant or deny the association request based on predetermined parameters (e.g., current load, etc.).

When the AP 30 grants the association request, an authentication process is executed. The authentication process may be performed by the MU 50 and the AP 30, or in conjunction with the NMA 60. In one embodiment, the MU 50 transmits an authentication request including first source data (e.g., a medium access control (“MAC”) address of the MU 50) to the AP 30. The AP 30 in turn transmits an authentication response accepting or rejecting the authentication request. The authentication request and authentication response may be encrypted prior to transmission to preserve the integrity of the WLAN. Thus, the MU 50 and the AP 30 may share a first encryption key (i.e., a Wired Equivalent Privacy (“WEP”) key).

In another embodiment, the MU 50 transmits the authentication request to the AP 30, which generates a modified authentication request by encrypting the first source data and a second source data (e.g., a MAC address of the AP 30). The AP 30 may encrypt the first and second source data using a second key (e.g., a regular session encryption key), which is shared between the AP 30 and the NMA 60. The AP 30 transmits the modified authentication request to the NMA 60 which decrypts the modified authentication request using the second key. The NMA 60 accesses an authentication list which includes the first source data for each MU authorized to access the network 65. The NMA 60 queries the authentication list for the first source data of the MU 50. If the first source data matches an entry on the list, the NMA 60 generates and encrypts (using the second key) an authentication accept message, which is transmitted to the AP 30. The AP 30 decrypts the authentication accept message and transmits it to the MU 50, which may access the network 65. If the first source data does not match any entry on the list, the NMA 60 transmits an authentication denied message to the AP 30, which is decrypted and forwarded to the MU 50.

In a conventional 802.11 wireless network, the authentication process is repeated each time the MU 50 attempts to communicate with a new AP (e.g., when the MU 50 migrates into a different coverage area, determines that the new AP is better suited to handle the MU 50, etc.). The repetition delays access to the network 65 for the MU 50. Also, each time the authentication process is repeated, new encryption keys may be used.

According to the present invention, the MU 50 may initiate communication with an AP without having to perform the authentication process for each AP in the WLAN. In one embodiment, after the MU 50 is authenticated by one AP, authentication information (e.g., encryption key, encryption type, MAC address, etc.) for the MU 50 may be transmitted to one or more remaining APs 10-40 in the WLAN. Thus, after an initial authentication of the MU 50 with the one AP, the MU 50 may not have to re-authenticate with the remaining AP, eliminating a time associated with re-authentication.

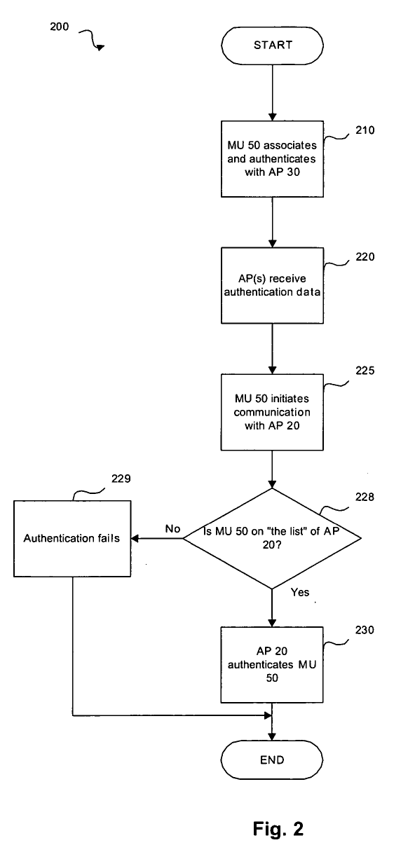

FIG. 2 shows an exemplary embodiment of a method 200 according to the present invention. The method 200 of FIG. 2 will be described with reference to the system 1 shown in FIG. 1.

In step 210, the MU 50 may be associated and authenticated as described above. That is, the MU 50 may transmit the association request to the AP 30, which may then grant or deny the association request. When the association request is granted, the authentication process may be executed, whereby the authentication information is transmitted by the MU 50 to the AP 30 and potentially by the AP 30 to the NMA 60. After completion of the association and authentication processes, the MU 50 may establish a connection to the network 65 via the AP 30. Although the method 200 will be described with reference to the AP 30 performing the authentication process, those of skill in the art will understand that in another exemplary embodiment, the NMA 60 may control the entire authentication process.

In step 220, the authentication information may be transmitted by the AP 30 or the NMA 60 to each AP on a predetermined list of APs. For example, the predetermined list may be generated as a function of a location of the MU 50. That is, the APs (e.g., APs 10-40) which are within a predetermined range of the MU 50 may be on the list. Thus, the APs 10-40 may anticipate an arrival of the MU 50 and an attempt to associate, as will be described below. Further, the list may be transmitted to the MU 50 so that, when choosing an AP with which to associate, the MU 50 may consult the list. That is, the MU 50 may “prefer” the AP(s) on the list (e.g., when roaming).

In step 225, the MU 50 attempts to initiate communication with the AP 20 by transmitting an association request thereto. That is, while the MU 50 is migrating within the WLAN, the MU 50 may determine that the AP 20 may better handle communication (e.g., increased received signal strength indicator (“RSSI”) value, less load, etc.). Thus, the MU 50 may attempt to establish a connection to the network 65 via the AP 20 and terminate the connection with the AP 30.

In step 228, the AP 20 determines whether the MU 50 is included on the predetermined list. When the MU 50 is not on the list, the authentication by the AP 20 may fail, as shown in step 229. Alternatively, the AP 20 may execute a conventional authentication with the MU 50. Thus, even when the MU 50 is not on the list, it may still be granted access to the network 65. When the AP 20 does grant the association request, the MU 50 has succeeded in establishing communication with the AP 20.

In step 230, the AP 20 authenticates the MU 50. Because the AP 20 is already equipped with the authentication information of the MU 50, the authentication process described above need not be performed again. That is, the AP 20 knows that the MU 50 is authorized to connect to the network 65. Therefore, the connection between the MU 50 and the AP 20 may be established in less time, while maintaining reliability. Thus, the MU 50 may move seamlessly within the WLAN and maintain its connection to the network 65 without the delay caused by repetition of the authentication process.

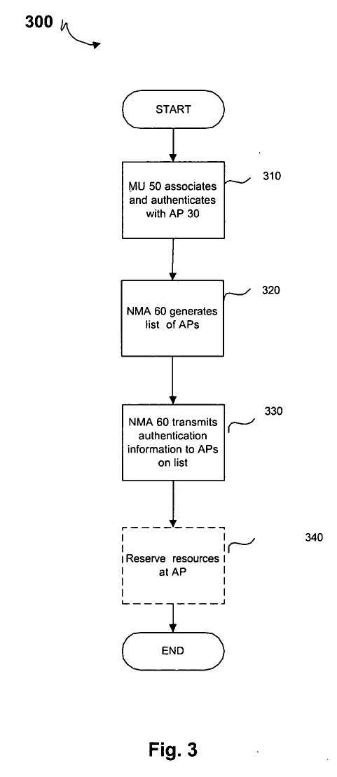

FIG. 3 shows another method 300 according to the present invention. In step 310, the MU 50 is associated with and authenticated by the AP 30. In this embodiment, the MU 50 may transmit the authentication request to the AP 30, which forwards the request to the NMA 60. The NMA 60 compares the first source data in the authentication request to the authentication list. If the NMA 60 identifies the first source data on the list, the authentication request may be granted. The MU 50 is thereby authorized to access the network 65. In maintaining the connection, the AP 30 is in constant communication with the NMA 60. Accordingly, the AP 30 may provide the NMA 60 with any pertinent information (e.g., the geographic location of the MU 50).

In step 320, the NMA 60 generates a list of one or more APs as a function of a predetermined network condition. For example, the predetermined network condition may be a distance of the AP from the MU 50, and/or a load at the AP. In one embodiment, the MU 50 may perform a scan and report all APs within its range to the NMA 60. The NMA 60 may then generate an ordered list of the nearest APs from information (e.g., a RSSI) reported by the MU 50. In another embodiment, the NMA 60 may analyze a current load of each AP 10-40 in the WLAN. For example, the NMA 60 may consider a number of MUs connected to the network 65 through each AP, a current throughput of each AP, etc. The NMA 60 may thus determine which APs have the lightest loads, and accordingly generate a list. The NMA 60 may transmit the list of select APs to the MU 50, which may then prefer to communicate with those APs. Alternatively, the list may include every AP 10-40 in the WLAN.

The NMA 60 may also track a location of the MU 50 within the WLAN. The location of the MU 50 may be determined as a function of, for example, signal data (e.g., the RSSI) collected by the MU 50 and/or one or more of the APs 10-40. As understood by those of skill in the art, a coarse location of the MU 50 may be obtained utilizing the signal data from one or two APs, whereas a fine location may be obtained using at least three APs (i.e., a triangulation-approach). Because the location of the MU 50 may continually be monitored, the NMA 60 can thereby detect when the location has varied. Further, the NMA 60 may predict a future location of the MU 50 as a function of a path of movement of the MU 50. Thus, the list may include the APs which are within a communicable range of the future location of the MU 50.

In step 330, the NMA 60 transmits the authentication information to each AP on the list. The APs which receive the authentication information may thus anticipate communication with the MU 50. In one embodiment of the present invention, the AP 30 may transmit the list to the MU 50. Upon receiving the list, the MU 50 identifies the APs which are anticipating its arrival. Therefore, in a case where the MU 50 may choose an AP with which to communicate, the list may be ordered in a preference of APs as determined by the NMA 60. Alternatively, the NMA 60 may make the list available to all of the APs coupled thereto. Thus, when the AP receives an association request, it may access the list to determine if the associating MU is on the list.

In optional step 340, the APs on the list may execute a predetermined action (e.g., reserve a resource, such as bandwidth, to support a connection with the MU 50).

Because, the APs in the list receive the authentication information of the MU 50 prior to communication with the MU 50, the MU 50 may access the network 65 after the association request is granted by the AP 20.

The above exemplary embodiment was described with reference to a network which included a NMA 60. However, those of skill in the art will understand that the present invention may be implemented on other network architectures. In other types of network architectures, hardware devices other than a NMA (e.g., a network server, a wireless switch, etc.) may be used to track MUs through the network and transmit the authentication information to the appropriate AP.

The present invention may be beneficial with respect to reducing a roam time of an MU 50 which is traveling within the WLAN. Advantages include a reduction in dropped packets and a quicker connection to the network 65. The present invention may also be useful when the MU 50 is executing a VoIP application, where a delay in the connection to the network 65 may result in a diminished quality of service.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
transmitting, by a wireless computing unit, an association request and an authentication request to an access point (“AP”), the association request including an identifier of the unit and the authentication request including authentication data of the unit;
performing an authentication procedure of the unit as a function of the identifier and the authentication data;
adding the identifier and the authentication data to an authenticated list;
providing access to the list to at least one further AP; and
when the at least one further AP receives a further association request including the identifier from the unit, performing a further authentication procedure as a function of the identifier and the list.

2. The method according to claim 1, wherein the identifier includes a MAC address of the unit.

3. The method according to claim 1, wherein the authentication data includes an encryption key.

4. The method according to claim 1, further comprising:
adding an AP identifier to the list for each of the AP and the at least one further AP; and
providing access to the list to the unit.

5. The method according to claim 4, further comprising:
selecting, by the unit, the AP identifier based on a predetermined parameter and the list; and
transmitting the further association request as a function of the selection.

6. The method according to claim 1, further comprising:
selecting the at least one further AP as a function of at least one of: (i) a location of the unit, (ii) a load on the at least one further AP and (iii) a signal strength of the at least one further AP.

7. The method according to claim 1, further comprising:
reserving a resource on the at least one further AP.

8. The method according to claim 7, wherein the resource is a bandwidth.

9. The method according to claim 1, wherein the second performing step includes the following substeps:
determining whether the identifier is included in the list; and
when the identifier is included in the list, allowing the unit to conduct further wireless communications with the at least one further AP.

10. The method according to claim 1, wherein the unit includes at least one of a laser-based scanner, an image-based scanner, an RFID reader and a mobile computer.

11. A system, comprising:
a network management arrangement (“NMA”);
a plurality of access points (“AP”) including a first AP and at least one further AP; and
a wireless computing unit transmitting an association request and an authentication request to the first AP, the association request including an identifier of the unit and the authentication request including authentication data of the unit,
wherein, the NMA performs an authentication procedure of the unit as a function of the identifier and the authentication data, the NMA adding the identifier and the authentication data to an authenticated list, and
wherein, the NMA provides access to the list to the at least one further AP, and
wherein, when the at least one further AP receives a further association request including the identifier from the unit, the NMA performs a further authentication procedure as a function of the identifier and the list.

12. The system according to claim 11, wherein the identifier includes a MAC address of the unit.

13. The system according to claim 11, wherein the authentication data includes an encryption key.

14. The system according to claim 11, wherein the list includes an AP identifier for each of the first AP and the at least one further AP.

15. The system according to claim 14, wherein the list is provided to the unit.

16. The system according to claim 15, wherein the unit selects the AP identifier and transmits the further association request as a function of the selection.

17. The system according to claim 11, wherein the NMA selects the at least one further AP as a function of at least one of: (i) a location of the unit, (ii) a load on the at least one further AP and (iii) a signal strength of the at least one further AP.

18. The system according to claim 11, wherein the NMA reserves a resource on the at least one further AP.

19. The system according to claim 18, wherein the resource is a bandwidth.

20. The system according to claim 11, wherein the unit includes at least one of a laser-based scanner, an image-based scanner, an RFID reader, a cell phone and a mobile computer.

20. The system according to claim 11, wherein the NMA is a switch.

21. A device, comprising:
a processor;
a communication arrangement receiving, from a wireless computing unit, an association request and an authentication request, the association request including an identifier of the unit and the authentication request including authentication data of the unit; and
a memory,
wherein, the processor performs an authentication procedure of the unit as a function of the identifier and the authentication data,
wherein, the processor adds the identifier and the authentication data to an authenticated list stored in the memory,
wherein, the processor provides access to the list to at least one access point so that when the at least one access point receives a further association request from the unit, the access point grants the further association request.

22. The device according to claim 21, wherein the device includes a switch.

23. The device according to claim 21, wherein the unit is one of a laser-based scanner, an image-based scanner, an RFID reader, a cell phone, a laptop, a PDA and a handheld computer.

24. A method, comprising:
transmitting, by a wireless computing unit, an association request and an authentication request to an access point (“AP”), the association request including an identifier of the unit and the authentication request including authentication data of the unit;
performing an authentication procedure of the unit as a function of the identifier and the authentication data;
transmitting the identifier and the authentication data to at least one further AP;
generating a list including the AP and the at least one further AP;
transmitting the list to the unit;
when the at least one further AP receives a further association request including the identifier from the unit, granting the further association request.

25. The method according to claim 24, further comprising:
selecting, by the MU, the at least one further AP as a function of the list.
